(19) United States
(12) Patent Application Publication
(10) Pub. No.: US 2026/0184368 A1
(43) Pub. Date: Jul. 2, 2026

(54) METHODS AND APPARATUS FOR OPERATING A STEER-BY-WIRE STEERING SYSTEM FOR A VEHICLE

(71) Applicant: Ford Global Technologies, LLC, Dearborn, MI (US)

(72) Inventors: Alexander Hoerdemann, Aachen (DE); Florian Rath, Pulheim (DE); Simon Baales, Köln (DE); Uwe Hoffmann, Leverkusen (DE); Felix Weinreich, Dortmund (DE)

(21) Appl. No.: 19/434,679

(22) Filed: Dec. 29, 2025

(30) Foreign Application Priority Data
Dec. 30, 2024 (DE) 102024139911.2

(51) Int. Cl. B62D 6/00

(52) U.S. Cl. CPC B62D 6/003

(57) ABSTRACT

The disclosure relates generally to a method for operating a steer-by-wire steering system for a vehicle and a steer-by-wire steering system and, more particularly, to methods and apparatus for operating a steer-by-wire steering system for a vehicle. An example non-transitory computer readable storage medium comprising instructions to cause at least one programmable circuitry to determine a road wheel target angle for road wheels of a vehicle based on environmental data and steering wheel angle data associated with the vehicle, and if a difference between the road wheel target angle and yaw data associated with the vehicle exceeds a first threshold, determine an adjusted road wheel target angle.

### RELATED APPLICATION

This patent claims priority from DE Patent Application Number 102024139911.2, which was filed on Dec. 30, 2024, and is hereby incorporated herein by reference in its entirety.

### FIELD OF THE DISCLOSURE

The disclosure relates generally to a steer-by-wire steering system and, more particularly, to methods and apparatus for operating a steer-by-wire steering system for a vehicle.

### BACKGROUND

Steer-by-wire steering systems replace mechanical steering connections with electronic sensing, control, and actuation components. Driver steering inputs are processed to determine desired steering behavior, and feedback forces are generated to emulate steering feel without a physical linkage between a steering wheel and road wheels.

### BRIEF DESCRIPTION OF THE DRAWINGS

FIG. 1 depicts a vehicle including a steer-by-wire steering system in accordance with examples described herein.

FIG. 2 is a flowchart representative of example machine readable instructions and/or example operations that may be executed, instantiated, and/or performed by example programmable circuitry to implement the steer-by-wire steering system of FIG. 1.

FIG. 3 is a block diagram of an example processing platform including programmable circuitry structured to execute, instantiate, and/or perform the example machine readable instructions and/or perform the example operations of FIG. 2 to implement the steer-by-wire steering system of FIG. 1.

In general, the same reference numbers will be used throughout the drawing(s) and accompanying written description to refer to the same or like parts. The figures are not necessarily to scale.

### SUMMARY

An example vehicle comprising an environmental sensor, a steering wheel angle sensor, a yaw sensor a controller configured to determine a road wheel target angle for road wheels of the vehicle based on environmental data from the environmental sensor and steering wheel angle data from the steering wheel angle sensor, and if a difference between the road wheel target angle and yaw data of the yaw sensor exceeds a first threshold, determine an adjusted road wheel angle target.

An example non-transitory computer readable storage medium comprising instructions to cause at least one programmable circuitry to determine a road wheel target angle for road wheels of a vehicle based on environmental data and steering wheel angle data associated with the vehicle, and if a difference between the road wheel target angle and yaw data associated with the vehicle exceeds a first threshold, determine an adjusted road wheel target angle.

An example method comprising determining a road wheel target angle for road wheels of a vehicle based on environmental data associated with the vehicle and steering wheel angle data associated with the vehicle, if a difference between the road wheel target angle and yaw data associated with the vehicle exceeds a first threshold, determining an adjusted road wheel target angle, and causing a road wheel actuator of the vehicle to steer the road wheels based on the adjusted road wheel target angle.

### DETAILED DESCRIPTION

When a vehicle operates in an off road environment including low traction surfaces, the vehicle may stray from a desired trajectory. In some examples, the vehicle may stray from the desired trajectory if the terrain the vehicle is operating on is sloped. Drivers of the vehicle who are not experienced in such off road environments may go off the a trail or road of the off-road environment. Experienced drivers may counter steer in vehicles including conventional steering systems and correct the direction of the road wheels, for example uphill, to ensure that the vehicle follows the desired trajectory. However, this requires continuous manual steering input.

Examples described herein solve all or at least some of the above described challenges. Examples described herein provide for a steering system and a method for operating the steering system, via which full steering control can be generally ensured even on demanding road surfaces and in which a vehicle follows a target trajectory.

According to one aspect, some examples of the disclosure relate to a method of operating a steer-by-wire (SBW) steering system for a vehicle. The SBW steering system includes at least a steering wheel, a road wheel actuator, and a control device. The road wheel actuator is at least indirectly coupled with steerable road wheels. The method may include at least the following operations. Environmental data corresponding to an environment in which the vehicle is operating is received by the control device. A detected steering wheel angle of the steering wheel is received by the control device. A road wheel set angle for the steerable road wheels and/or a target trajectory of the vehicle are determined by the control device at least based on the received steering wheel angle and/or the received environmental data. A yaw rate of the vehicle is received or determined by the control device. The yaw rate of the vehicle is compared with the determined road wheel target angle and/or with the determined target trajectory of the vehicle by the control device. In some examples, an actual trajectory of the vehicle is compared with the determined target trajectory of the vehicle by the control device. An adjusted road wheel angle is determined by the control device for the steerable road wheels if a difference between the yaw rate and the determined road wheel target angle and/or the determined target trajectory exceeds a first difference threshold, or if a difference between the actual trajectory and the target trajectory exceeds a second difference threshold.

The method adapts the lateral guidance of the vehicle to a desired target trajectory or a detected steering wheel angle according to a steering input. SBW steering systems do not require mechanical coupling between the steering wheel and the steerable road wheels. Two actuator subsystems work together to steer the vehicle, a steering wheel actuator and a road wheel actuator. The steering wheel actuator generates feedback torque for the driver on the steering wheel, the steering wheel actuator is also known as a feedback actuator (FBA). The road wheel actuator regulates at least one, but typically more than one, steerable road wheels to the desired position. By mechanically decoupling the steering wheel from the steerable road wheels, the SBW steering system can include a variable steering ratio, which describes the dependence between these parameters.

In some examples, the variable steering ratio allows the control of the orientation of the steerable road wheels to be adapted to the driving situation to be able to precisely follow a desired target trajectory or steering wheel angle. This makes use of the fact that modern vehicles include environmental sensors that can be used to collect environmental data of the vehicle's surroundings. Based on the environmental data and/or the recorded steering wheel angle, target trajectories and/or road wheel target angles can be determined, which can be compared with corresponding actual values to determine a required adjustment. The target values can thus be followed more precisely, even if the driver is inexperienced in such driving situations. In addition, experienced drivers also benefit from the methods described herein, as comfort is increased, for example, because corrections do not have to be made manually.

In some examples, the control device outputs a control signal to an electric motor of the road wheel actuator or an inverter coupled to the electric motor based on the determined adjusted road wheel angle. This ensures the actual adjustment of the lateral guidance of the vehicle. The lateral guidance then follows the target values (e.g., the target trajectory and/or the road wheel target angle).

In some examples, the control device can determine an inclination (e.g., grade) and/or traction of a driving surface based on at least the received environmental when determining the road wheel target angle and/or the target trajectory of the vehicle. Depending on the grade and/or the traction of the driving surface, the external conditions for the vehicle in the driving situation vary, for example in mud, snow or ice. Therefore, considering the grade and/or the traction of the driving surface allows for greater precision in determining the adjusted road wheel angle, as the road wheel target angle and/or the target trajectory can be estimated more precisely. In some examples, the determined grade and/or traction of the surface can also be considered when determining the adjusted road wheel angle. As a result, the adapted road wheel angle is more precisely adapted to the respective driving conditions.

In some examples, the first difference threshold and/or the second difference threshold are variable. For example, the differential thresholds can be adapted to the respective driving situation. In some examples, the first difference threshold and/or the second difference threshold depends at least on the determined grade and/or the traction of the driving surface. This allows the thresholds to be adapted to the respective characteristics of the driving surface.

In some examples, the control device can detect or receive a vehicle speed of the vehicle. Determining the adjusted road wheel angle may depend on the vehicle speed being less than or equal to an adjustable speed threshold. This allows the adjustment of the road wheel angle to be limited for a defined speed range. The speed threshold is in some examples 30 km/h, further in some examples 20 km/h, further in some examples 15 km/h, further in some examples 10 km/h. As a result, the method is performed, especially at low vehicle speeds, so that the road wheel target angle and/or the target trajectory can be precisely followed.

In some examples, determining the adjusted road wheel angle may depend on user input. In particular, the method can be performed and/or activated based on the user's input. In some examples, user input can be made to cause the method to correct the vehicle trajectory. This means that the control device can issue a request to a user of the vehicle, whereby the actual determination of the adjusted road wheel angle in such examples depends on a corresponding user input. The method is in some examples automated. For example, the method can be triggered based on user input, or as soon as the first difference threshold and/or the second difference threshold is exceeded.

In some examples, the control device triggers a notification to a driver of the vehicle if it determines an adjusted road wheel angle. This informs the user of the assistance provided by the control device, so that the adjustment is not unexpected.

In some examples, the control device determines the vehicle's actual trajectory at least based on the acquired environmental data and/or the received steering wheel angle and/or yaw rate of the vehicle. When determining the vehicle's trajectory, the control device may also consider a detected road wheel angle, which is detected by at least one road wheel angle sensor. In this respect, the SBW steering system can at least include a road angle sensor that is configured to detect a road wheel angle of at least one steerable road wheel about the respective steering axle of the respective road wheel and transmit it to the control device. In some examples, a rack and pinion sensor can be used instead of a road wheel angle sensor. The rack and pinion sensor is configured to detect travel of a rack coupled to the steerable road wheels. Because the rack is coupled to the steerable road wheels, a shift in the rack immediately causes a change in the orientation of the steerable road wheels.

In some examples, the vehicle may also include at least one wheel sensor assigned to at least one road wheel and configured to individually record the speed of the assigned road wheel in the circumferential direction (e.g., rolling direction). Based on the recorded speeds, the control device can determine, for example, the wheel-specific longitudinal slip and/or lateral slippage. Longitudinal wheel slip refers to the divergence of the wheel tread according to the wheel speed from the driving surface with which the respective wheel is (or should be) in frictional contact, whereby a tangential force counteracts the traction. The tangential force also causes side slippage. Traction means the transfer of the tractive force to drive the motor vehicle to the ground. A certain amount of longitudinal wheel slip and/or lateral slip can occur when the motor vehicle is powered, for example depending on the surface conditions and the type of tire. However, if the longitudinal wheel slip and/or the lateral slip becomes too large, the vehicle can no longer be guided precisely, measured by the steering input of the steering wheel (e.g., the steering wheel angle). In such examples, only insufficient lateral forces are transmitted, which are required for vehicle lateral guidance. The control device can consider the longitudinal wheel slip and/or lateral slip when determining the target trajectory and/or the actual trajectory to determine the difference between them.

In some examples, the control device considers control parameters from previous control periods when determining the target trajectory and/or the actual trajectory. By considering successive control periods, the actual trajectory and the target trajectory can be precisely determined on the basis of the recorded parameters and user inputs, such as the steering inputs. In addition, the control device can also estimate the the difference between the target trajectory and the actual trajectory more precisely.

The disclosure also relates to a computer program product, comprising instructions which, when executed by a processor, cause the processor to perform at least partially the method described above, for example, the computational, comparison, and output operations. The benefits achieved by the method described herein are also achieved in a corresponding manner by the computer program product.

The disclosure also relates to a non-transitory computer-readable storage medium, comprising instructions which, when executed by a processor, cause the computer program product to execute at least partially the method described above, for example, the computational, comparison, and output operations. The advantages achieved by the method described herein are also achieved in a corresponding way by the non-transitory computer-readable storage medium.

The disclosure also relates to a SBW steering system for a vehicle. The SBW steering system includes at least a steering wheel actuator, a road wheel actuator, and a control device. The road wheel actuator is coupled with steerable road wheels. The control device is configured to receive recorded environmental data of an environment of the vehicle, to receive a detected steering wheel angle of the steering wheel, determine a road wheel target angle for the steerable road wheels and/or a target trajectory of the vehicle at least based on the received steering wheel angle and/or the received environmental data, to receive or determine a yaw rate of the vehicle, compare the yaw rate of the vehicle with the determined road wheel target angle and/or with the determined target trajectory of the vehicle, and/or compare an actual trajectory of the vehicle with the determined target trajectory of the vehicle, and to determine an adjusted road wheel angle for the steerable road wheels if a difference between the yaw rate and the determined road wheel target angle and/or the determined target trajectory exceeds a first difference threshold, or if a difference between the actual trajectory and the target trajectory exceeds a second difference threshold.

The advantages achieved by the method are also achieved in a corresponding way by the SBW steering system. In particular, the steering of the road wheels can also be adapted for challenging driving surfaces in such a way that the actual lateral guidance of the vehicle is adapted to the target trajectory and/or the road wheel target angle. This ensures reduced divergence from the desired vehicle trajectory, which means that lateral guidance corresponds more precisely to the driver's input.

In some examples, the SBW steering system includes at least one steering wheel sensor, which is configured to detect a steering wheel angle and/or steering wheel speed of the steering wheel. The steering wheel angle and/or steering wheel speed can be detected with respect to a reference position, such as a zero position (e.g., corresponding to a straight line). The steering wheel sensor transmits the recorded measurement data to the control device. The steering wheel sensor can be directly coupled to the steering wheel, but can also be coupled to the steering column, as the steering column is rigidly coupled to the steering wheel and a rotation of the steering wheel thus translates directly into a rotation of the steering column.

In some examples, the vehicle includes a vehicle control device that has an advanced driving assistance system. The driver assistance system can be used to perform a route following function. The route following function regulates the lateral guidance of the vehicle in a semi-autonomous or autonomous manner. The vehicle is steered in such a way that a destination predefined or determined by the driver is reached. Typically, the route following function makes use of environmental data, position data, and/or vehicle data that is recorded using environmental sensors, a speed sensor, and/or a speed change sensor of the vehicle or determined via a position signal receiver. For example, the route following function can steer the vehicle according to the course of the road and adjust the vehicle's lateral guidance.

In some examples, the vehicle and/or the SBW steering system may include at least one environmental sensor that is configured to collect environmental data of the vehicle's environment. For example, the environmental sensor can be a radar sensor, a lidar sensor, a camera sensor, an infrared sensor, or a combination of these. The environmental sensor can be part of an advanced driver assistance system. The sensor data from the environmental sensor can then be used as part of autonomous or semi-autonomous driving functions, for example by the vehicle control device.

In some examples, the vehicle may include at least one yaw rate sensor that is configured to detect a yaw rate of the vehicle (e.g., rotation around the vehicle's vertical axis and transmit it to the control device and/or the vehicle control device.

In some examples, the vehicle includes a user interface, such as an infotainment device, via which the control device can issue notifications to the user and/or through which a vehicle user can enter user input.

The disclosure also relates to a vehicle including a SBW steering system as described herein or a SBW steering system operable by a method as described herein. The benefits achieved by the method described herein are also achieved in a corresponding manner by the vehicle.

For the purposes of disclosure, vehicles may include land vehicles, namely, inter alia, off-road and on-road vehicles such as passenger cars, buses, trucks and other commercial vehicles. Motor vehicles can be manned or unmanned. The vehicles can include an internal combustion engine, alternatively an electric motor to drive them, or they can be hybrid vehicles.

All the features mentioned below with respect to the examples and/or accompanying figures may be combined, alone or in any sub-combination, with features of the example, including features of preferred examples.

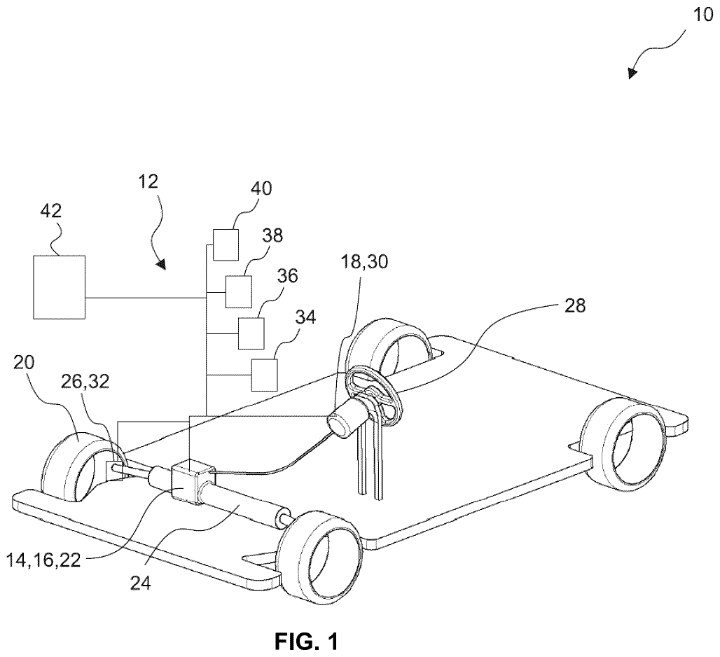

FIG. 1 shows a vehicle 10 including a SBW steering system 12. The SBW steering system 12 includes a SBW function 14 implemented by a control device 16. The SBW steering system 12 also includes a steering wheel actuator 18 and a road wheel actuator 14. The steering wheel actuator 18 and the road wheel actuator 14 are linked to each other. The road wheel actuator 14 is indirectly coupled with steerable road wheels 20 of the vehicle 10. The road wheel actuator 14 includes an electric motor 22 coupled to a rack 24. The rack 24 is coupled with the steerable road wheels 20 of the vehicle 10. The displacement of the rack 24 with respect to a reference position, such as a zero position (e.g., straight line), results in a change in the orientation of the steerable road wheels 20 around the steering axles of the respective road wheels 20.

The SBW steering system 12 includes a road wheel angle sensor 26, which is configured to detect a steering angle of the steerable road wheels 20 about the respective wheel axle and transmit it to the control device 16 and/or the steering wheel actuator 18. In some examples, instead of a road wheel angle sensor 26, the SBW steering system 12 can also include a rack and pinion sensor that detects a position of the rack 24 with respect to a reference position. Because the rack 24 is coupled to the steerable road wheels 20, a deflection of the rack 24 leads to a rotation of the steerable road wheels 20. In some examples, several sensor units can also form a sensor together, which enables mutual plausibility checks and redundancy.

The SBW steering system 12 also includes a steering wheel 28, to which the steering wheel actuator 18 is at least indirectly coupled, for example via a steering column. The steering wheel actuator 18 is configured to apply feedback torque to the steering wheel 28, giving the driver of the vehicle 10 a sense of lateral control. The driver of vehicle 10 can use the steering wheel 28 to perform steering input for vehicle 10.

The SBW Steering System 12 also includes at least one steering wheel sensor 30 that is configured to detect a steering wheel angle (e.g., a steering wheel position) of the steering wheel 28 in relation to a reference position, such as a center position (e.g., zero position). Consequently, the steering wheel sensor 30 can be used to detect steering input of the driver of the vehicle 10 based on the steering wheel 28. In this respect, a steering input defines a specific current steering wheel angle and steering wheel speed.

A current steering input corresponds to a specific current road wheel target angle, according to which the steerable road wheels 20 should be aligned. Because the road wheels 20 are at least indirectly coupled with the rack 24, a steering input is equivalent to a rack and pinion target stroke of the rack 24, according to which the rack 24 is to be moved so that a desired orientation of the road wheels 20 is achieved. By changing the steering wheel position, the current steering input is dynamically changed by the driver, which in turn leads to a dynamic change in the rack and pinion target stroke. The dependence of the rack and pinion target stroke on the current steering input in the form of the current steering wheel angle is considered by the control device 16 within the framework of a steering ratio. The steering ratio thus describes how the rack and pinion target stroke varies dynamically depending on the steering wheel angle. In general, the steering ratio is variable (e.g., variable steering ratio). This means that the rack and pinion target stroke, especially for small steering wheel angles, can depend linearly on the steering wheel angle in relation to the reference position (e.g., center position). For larger steering wheel angles, a transition to a non-linear dependency ratio is considered.

In some examples, the steering wheel sensor 30 is integrated into the steering wheel actuator 18. However, in other examples, the steering wheel sensor 30 may be separate from the steering wheel actuator 18. The steering wheel sensor 30 is configured to transmit the detected steering wheel angle to the road wheel actuator 14 and/or the steering wheel actuator 18.

The control device 16 is also configured in such a way that it outputs corresponding control signals to the electric motor 22 or an inverter coupled to the electric motor 22. To execute the corresponding control routines, the control device 16 can consider other parameters of the vehicle 10, such as the vehicle speed. To detect vehicle speed, the vehicle 10 is equipped with a speed sensor 32, which is equipped to detect vehicle speed and transmit it to road wheel actuator 14 and/or the steering wheel actuator 18. For example, the speed sensor 32 can be based on yaw rate sensors that detect the speeds of the road wheels 20. From this, the individual wheel slip can also be determined. Based on the actuator signal, an output torque is provided by the electric motor 22 of the road wheel actuator 14 to align the steerable road wheels 20 accordingly. The output torque is exerted from the electric motor 22 of the road wheel actuator 14 to the rack 24, so that an orientation of the steerable road wheels 20 is indirectly varied.

The road wheel angle sensor 26 detects a road wheel angle of the steerable road wheels 20 and transmits the detected road wheel angle to the road wheel actuator 14 and the steering wheel actuator 18. The steering wheel actuator 18 determines a corresponding feedback torque, which is output to the steering wheel 28.

The vehicle 10 also includes environmental sensors 34 of an advanced driver assistance system. The environmental sensors 34 are configured to collect environmental data of the environment of the vehicle 10 and transmit it to the road wheel actuator 14 and/or the steering wheel actuator 18. The environmental sensors 34 can be radar sensors, lidar sensors, camera sensors, infrared sensors or combinations of these.

In some examples, the control device 16 is coupled with a storage device 36 (e.g., data storage), in which control parameters from past control periods are stored. The vehicle 10 also includes at least one yaw rate sensor 38 which is configured to detect a yaw rate of vehicle 10 corresponding to rotation around the vehicle's vertical axis and to provide it to control device 16. The vehicle 10 also includes at least one user interface 40, such as an infotainment system that allows the control device to issue 16 notifications and allow the driver to enter user input. In some examples, the SBW steering system 12 can also include several similar and generally functional components, such as several steering wheel sensors 30, which ensures redundancy.

In some examples, the vehicle 10 includes a vehicle control device 42. The vehicle control device 42 is configured to perform autonomous or semi-autonomous driving functionalities. For example, the vehicle control device 42 can autonomously influence the lateral guidance of vehicle 10. For this purpose, the vehicle control device 42 can, for example, set a input for the steering wheel angle, which is subsequently adjusted accordingly by steering wheel actuator 18 of the SBW steering system 12. The steering wheel angle is detected by the steering wheel sensor 30 and transmitted to the road wheel actuator 14 or is transmitted directly to the road wheel actuator 14 by the vehicle control device 42.

In the illustrated example of FIG. 1, the SBW steering system 12 is shown as front-axle steering. The vehicle 10 and the SBW steering system 12 can also in some examples have other steerable road wheels 20, such as rear wheels coupled with an additional common RWA 14.

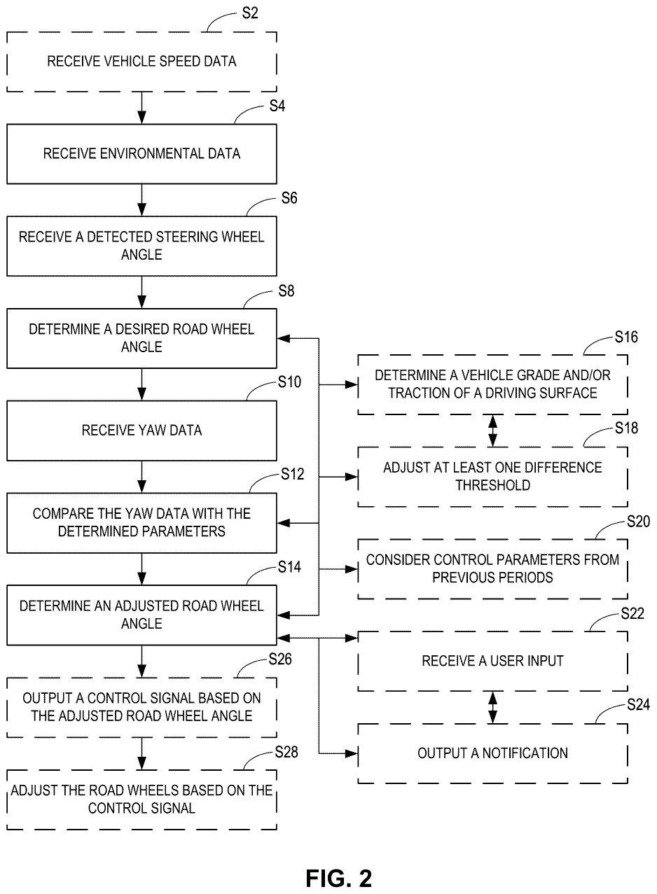

FIG. 2 is a flowchart representative of example machine readable instructions and/or example operations that may be executed, instantiated, and/or performed by example programmable circuitry to implement the steer-by-wire steering system 12 of FIG. 1. In the optional operation S2, the control device 16 receives and considers the vehicle speed of the vehicle 10. For example, the speed sensor 32 can be used for this purpose. The received vehicle speed is, in some examples, compared with a speed threshold value by the control device 16. For example, the speed threshold is 10 km/h. If the actual vehicle speed is less than the speed threshold, control proceeds to operation S4. Otherwise, the proceedings may be terminated.

In the subsequent operation S4, the control device receives 16 acquired environmental data from an environment of the vehicle 10. The environmental data is collected by the environmental sensor 34 and transmitted to the control device 16.

Subsequently, the control device 16 in operation S6 receives the detected steering wheel angle of steering wheel 28. The steering wheel angle is detected by the steering wheel sensor 30 and transmitted to the control device 16.

In the next operation S8, the control device 16 determines a road wheel target angle for the steerable road wheels 20 and/or a target trajectory of the vehicle 10 at least based on the received steering wheel angle and/or the received environmental data. The steering input provided by the driver (e.g., via the steering wheel angle) determines how the vehicle 10 should be steered. Specifically, what road wheel target angle and/or what target trajectory the vehicle should follow in order to reflect the driver's steering input. Alternatively or additionally, the environmental data can also be considered, as the environmental data can be used to identify and consider, for example, intended lanes.

In the subsequent operation S10, the control device 16 then receives the yaw rate (e.g., data) of the vehicle 10, which can be detected via a yaw rate sensor 38 and transmitted to the control device 16. The yaw rate reflects the rotation of vehicle 10 around the vehicle's vertical axis and thus characterizes, at least in part, the actual lateral guidance of the vehicle 10.

Subsequently, in operation S12, the control device 16 compares the yaw rate of vehicle 10 with the determined road wheel target angle, the determined target trajectory of vehicle 10, and/or an actual trajectory of vehicle 10. The trajectory of the vehicle 10 can be determined, for example, using wheel sensors that record the speed of a road wheel 20 to which they are assigned. Based on the recorded speeds, a wheel-specific wheel longitudinal slip and/or lateral slip can be determined, which allows conclusions to be drawn about the extent to which the actual trajectory diverges from the target trajectory. Thus, based on the detected steering wheel angle, the environmental data, the longitudinal wheel slip, and/or the side slip, both the actual trajectory of vehicle 10 and the target trajectory of vehicle 10 can be determined by the control device 16.

Subsequently, the control device 16 determines an adjusted road wheel angle for the steerable road wheels 20 in operation S14 if a difference between the yaw rate and the determined road wheel target angle and/or the determined target trajectory exceeds a first difference threshold value, or if a displacement difference between the actual trajectory and the target trajectory exceeds a second difference threshold value. This allows the difference between the parameters mentioned, which is caused by the driving conditions, to be precisely compensated for, so that the actual parameters can be adjusted to the target parameters. In particular, the differences compared to previous steering systems can be reduced. For this purpose, the control device 16 can, for example, use the variable and thus adjustable steering ratio.

In some examples, the steering ratio can be variable. For example, the steering ratio can be variable for small road wheel target angles measured at the zero position (e.g., straight alignment) it can run linearly and have a non-linear dependency ratio for larger road wheel target angles. However, in such examples, the steering ratio can be unchangeable (e.g., it cannot be additionally adjusted by the control device 16). Rather, the adjustment of the actual parameters to the target parameters is brought about by the adjustment of the road wheel angle, which leads to an indirect alignment of the actual parameters to the target parameters. In other words, the steering ratio does not have to be additionally varied during the method.

In some examples, operations S8, S12, and S14 can be further trained in various ways, for example using the optional operations S16, S18, S20 or combinations thereof. For example, according to the optional operation S16, the control device 16 can determine a grade and/or traction of a driving surface based on at least the received environmental data. The grade and/or traction of the driving surface thus determined may be considered by the control device 16 when determining the road wheel target angle, the target trajectory of the vehicle 10, and/or when determining the adjusted road wheel angle for the steerable road wheels 20. Alternatively or additionally, the control device 16 can also use other sensors of the vehicle 10 to determine the grade, such as position sensors and/or gyroscopes.

In addition, the optional operation S18 can be considered, in which the control device 16 adjusts the first differential threshold and/or the second differential threshold based on the determined grade and/or the traction of the driving surface from the optional operation S16. This means that at least one difference threshold is adapted to the respective driving situational circumstances. For example, a lower difference threshold value can be considered for a higher traction value to compensate for differences as immediately as possible.

Furthermore, the optional operation S20 can be used, in which the control device 16 considers control parameters of past control periods. This allows temporal developments of both the actual parameters and the target parameters to be determined. For example, the temporal development of the road wheel target angle and/or the target trajectory can be determined. In addition, the regulatory parameters of past regulatory periods can of course also be considered with regard to the development of the differences caused by the control device 16. In this way, the control device 16 can evaluate whether the difference between the yaw rate and the determined road wheel target angle and/or the determined target trajectory or the distance difference between the actual trajectory and the target trajectory increases or decreases.

In addition, operation S14 can be further trained by the optional operations S22 and S24. In accordance with the optional operation S22, the control device 16 determines the adjusted road wheel angle only if it has previously received a corresponding user input. The user input can be entered by the driver of vehicle 10, for example, using user interface 40. In some examples, the driver of vehicle 10 can make a user input to activate the functionality of the method. If no corresponding user input is made, the method may be deactivated.

In some examples, the control device 16 can issue an enable request to the driver of vehicle 10 using the user interface 40, for example if the control device 16 detects a difference that is greater than the corresponding difference threshold. If the driver of vehicle 10 then makes a user input and enables the method, the adjusted road wheel angle is determined by the control device 16. In such examples, if no corresponding approval is made based on user input, the determination of the adjusted road wheel angle is prevented.

The optional operation S24 can be used by the control device 16 to issue a notification to the driver of the vehicle 10, provided that an adjusted road wheel angle is determined by the control device 16. This informs the driver of vehicle 10 of the adjustment of the lateral guidance of vehicle 10 caused by the control device 16. In some examples, the procedure is automated and does not depend on user input or user approval. In such examples, the comfort for the driver of vehicle 10 is particularly high.

Following operation S14, the method may include the optional operation S26, in which the control device 16 outputs an actuator signal to the electric motor 22 or an inverter coupled to the electric motor 22 based on the determined adjusted road wheel angle.

According to the following optional operation S28, the steerable road wheels 20 are adjusted according to the control signal from the optional operation S26 so that their orientation corresponds to the adjusted road wheel angle determined in operation S14. This means that the steerable road wheels 20 are rotated around the respective wheel steering axle.

The method enables the lateral guidance of the vehicle 10 to be adapted, especially on challenging driving surfaces, where differences between the target parameters and the actual parameters of the lateral guidance of the vehicle 10 occur depending on the driving situation. Such differences can occur, for example, on sloping off-road roads with slippery, low traction surfaces at low speeds, which can cause the vehicle 10 to slip sideways and possibly stray from a desired path. Due to the method, smaller manual continuous steering inputs may be necessary to achieve an adjustment of the lateral guidance to the target parameters. This means that lateral control of the vehicle 10 is more precise than before, even on challenging driving surfaces.

Example instructions and/or operations of FIG. 2 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, a hard disk drive (HDD), a flash memory, a read-only memory (ROM), a compact disc (CD), a digital versatile disc (DVD), a cache, a random-access memory (RAM) of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random-access memory of any type, read-only memory of any type, solid-state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

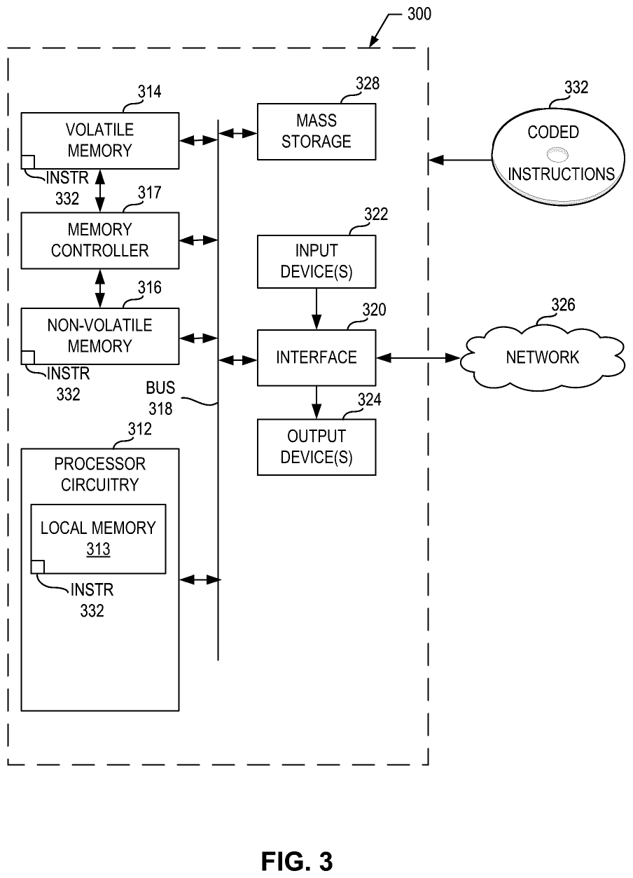

FIG. 3 is a block diagram of an example programmable circuitry platform 300 structured to execute and/or instantiate the example machine-readable instructions and/or the example operations of FIG. [Flowcharts] to implement examples disclosed herein. The programmable circuitry platform 300 can be, for example, a control device, an electronic control unit (ECU), a self-learning machine (e.g., a neural network), or any other type of computing and/or electronic device.

The programmable circuitry platform 300 of the illustrated example includes programmable circuitry 312. The programmable circuitry 312 of the illustrated example is hardware. For example, the programmable circuitry 312 can be implemented by one or more integrated circuits, logic circuits, field programmable gate arrays (FPGAs), microprocessors, central processor units (CPUs), graphics processor units (GPUs), vision processor units (VPUs), digital signal processors (DSPs), and/or microcontrollers from any desired family or manufacturer. The programmable circuitry 312 may be implemented by one or more semiconductor based (e.g., silicon based) devices.

The programmable circuitry 312 of the illustrated example includes a local memory 313 (e.g., a cache, registers, etc.). The programmable circuitry 312 of the illustrated example is in communication with main memory 314, 316, which includes a volatile memory 314 and a non-volatile memory 316, by a bus 318. The volatile memory 314 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 316 may be implemented by flash memory and/or any other desired type of memory device. Access to the main memory 314, 316 of the illustrated example is controlled by a memory controller 317. In some examples, the memory controller 317 may be implemented by one or more integrated circuits, logic circuits, microcontrollers from any desired family or manufacturer, or any other type of circuitry to manage the flow of data going to and from the main memory 314, 316.

The programmable circuitry platform 300 of the illustrated example also includes interface circuitry 320. The interface circuitry 320 may be implemented by hardware in accordance with any type of interface standard, such as a controller area network (CAN), an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 322 are connected to the interface circuitry 320. The input device(s) 322 permit(s) a user (e.g., a human user, a machine user, etc.) to enter data and/or commands into the programmable circuitry 312. The input device(s) 322 can be implemented by, for example, an audio sensor, a microphone, a camera (still or video), a button, a touchscreen, and/or a voice recognition system.

One or more output devices 324 are also connected to the interface circuitry 320 of the illustrated example. The output device(s) 324 can be implemented, for example, by display devices (e.g., a light emitting diode (LED), an organic light emitting diode (OLED), a liquid crystal display (LCD), an in-place switching (IPS) display, a touchscreen, etc.), a tactile output device, and/or speaker. The interface circuitry 320 of the illustrated example, thus, typically includes a graphics driver card, a graphics driver chip, and/or graphics processor circuitry such as a GPU.

The interface circuitry 320 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 326. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 300 of the illustrated example also includes one or more mass storage discs or devices 328 to store firmware, software, and/or data. Examples of such mass storage discs or devices 328 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or solid-state drives (SSDs).

The machine-readable instructions 332, which may be implemented by the machine-readable instructions of FIG. [Flowcharts], may be stored in the mass storage device 328, in the volatile memory 314, in the non-volatile memory 316, and/or on at least one non-transitory computer readable storage medium such as a CD or DVD which may be removable.

Although the disclosure has been presented and described in relation to one or more examples, after reading and understanding this description and the accompanying drawings, the skilled person will be able to make equivalent changes and modifications.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable operation of steer-by-wire steering systems for a vehicle. Further examples and combinations thereof include the following:

Example 1 includes a vehicle comprising an environmental sensor, a steering wheel angle sensor, a yaw sensor a controller configured to determine a road wheel target angle for road wheels of the vehicle based on environmental data from the environmental sensor and steering wheel angle data from the steering wheel angle sensor, and if a difference between the road wheel target angle and yaw data of the yaw sensor exceeds a first threshold, determine an adjusted road wheel angle target.

Example 2 includes the vehicle of example 1, wherein the controller is further configured to cause a road wheel actuator of the vehicle to steer the road wheels based on the adjusted road wheel target angle.

Example 3 includes the vehicle of any one or more of examples 1-2, wherein the controller is configured to determine the road wheel target angle further based on a grade of a driving surface associated with the vehicle.

Example 4 includes the vehicle of any one or more of examples 1-3, wherein the controller is configured to determine the road wheel target angle further based on a traction of a driving surface associated with the vehicle.

Example 5 includes the vehicle of any one or more of examples 1-4, wherein the controller is to determine the adjusted road wheel target angle if a difference between the road wheel target angle and an actual trajectory of the vehicle exceeds a second threshold.

Example 6 includes the vehicle of example 5, wherein the controller is configured to adjust at least one of the first threshold or the second threshold based on a grade or a traction of a driving surface associated with the vehicle.

Example 7 includes the vehicle of any one or more of examples 1-6, wherein the controller is to determine the adjusted road wheel target angle if the difference between the road wheel target angle and the yaw data is exceeded and a vehicle speed is less than a third threshold.

Example 8 includes a non-transitory computer readable storage medium comprising instructions to cause at least one programmable circuitry to determine a road wheel target angle for road wheels of a vehicle based on environmental data and steering wheel angle data associated with the vehicle, and if a difference between the road wheel target angle and yaw data associated with the vehicle exceeds a first threshold, determine an adjusted road wheel target angle.

Example 9 includes the non-transitory computer readable storage medium of example 8, wherein the at least one programmable circuitry is to cause a road wheel actuator of the vehicle to steer the road wheels based on the adjusted road wheel target angle.

Example 10 includes the non-transitory computer readable storage medium of any one or more of examples 8-9, wherein the at least one programmable circuitry is to determine the road wheel target angle further based on a grade of a driving surface associated with the vehicle.

Example 11 includes the non-transitory computer readable storage medium of any one or more of examples 8-10, wherein the at least one programmable circuitry is to determine the road wheel target angle further based on a traction of a driving surface associated with the vehicle.

Example 12 includes the non-transitory computer readable storage medium of any one or more of examples 8-11, wherein the at least one programmable circuitry is to determine the adjusted road wheel target angle if a difference between the road wheel target angle and an actual trajectory of the vehicle exceeds a second threshold.

Example 13 includes the non-transitory computer readable storage medium of example 12, wherein the at least one programmable circuitry is to adjust at least one of the first threshold or the second threshold based on a grade or traction of a driving surface associated with the vehicle.

Example 14 includes the non-transitory computer readable storage medium of any one or more of examples 8-13, wherein the at least one programmable circuitry is to determine the adjusted road wheel target angle if the difference between the road wheel target angle and the yaw data is exceeded and a vehicle speed is less than a third threshold.

Example 15 includes a method comprising determining a road wheel target angle for road wheels of a vehicle based on environmental data associated with the vehicle and steering wheel angle data associated with the vehicle, if a difference between the road wheel target angle and yaw data associated with the vehicle exceeds a first threshold, determining an adjusted road wheel target angle, and causing a road wheel actuator of the vehicle to steer the road wheels based on the adjusted road wheel target angle.

Example 16 includes the method of example 15, wherein determining the road wheel target angle is further based on a grade of a driving surface associated with the vehicle.

Example 17 includes the method of any one or more of examples 15-16, wherein determining the road wheel target angle is further based on a traction of a driving surface associated with the vehicle.

Example 18 includes the method of any one or more of examples 15-17, wherein if a difference between the road wheel target angle and an actual trajectory of the vehicle exceeds a second threshold, further including determining the adjusted road wheel target angle.

Example 19 includes the method of example 18, further including adjusting at least one of the first threshold or the second threshold based on a grade or a traction of a driving surface associated with the vehicle.

Example 20 includes the method of any one or more of examples 15-19, wherein if the difference between the road wheel target angle and the yaw data is exceeded and a vehicle speed is less than a third threshold, determining the adjusted road wheel target angle.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A vehicle comprising:
an environmental sensor;
a steering wheel angle sensor;
a yaw sensor
a controller configured to:
determine a road wheel target angle for road wheels of the vehicle based on environmental data from the environmental sensor and steering wheel angle data from the steering wheel angle sensor; and
if a difference between the road wheel target angle and yaw data of the yaw sensor exceeds a first threshold, determine an adjusted road wheel angle target.

2. The vehicle of claim 1, wherein the controller is further configured to cause a road wheel actuator of the vehicle to steer the road wheels based on the adjusted road wheel target angle.

3. The vehicle of claim 1, wherein the controller is configured to determine the road wheel target angle further based on a grade of a driving surface associated with the vehicle.

4. The vehicle of claim 1, wherein the controller is configured to determine the road wheel target angle further based on a traction of a driving surface associated with the vehicle.

5. The vehicle of claim 1, wherein the controller is to determine the adjusted road wheel target angle if a difference between the road wheel target angle and an actual trajectory of the vehicle exceeds a second threshold.

6. The vehicle of claim 5, wherein the controller is configured to adjust at least one of the first threshold or the second threshold based on a grade or a traction of a driving surface associated with the vehicle.

7. The vehicle of claim 1, wherein the controller is to determine the adjusted road wheel target angle if the difference between the road wheel target angle and the yaw data is exceeded and a vehicle speed is less than a third threshold.

8. A non-transitory computer readable storage medium comprising instructions to cause at least one programmable circuitry to:
determine a road wheel target angle for road wheels of a vehicle based on environmental data and steering wheel angle data associated with the vehicle; and
if a difference between the road wheel target angle and yaw data associated with the vehicle exceeds a first threshold, determine an adjusted road wheel target angle.

9. The non-transitory computer readable storage medium of claim 8, wherein the at least one programmable circuitry is to cause a road wheel actuator of the vehicle to steer the road wheels based on the adjusted road wheel target angle.

10. The non-transitory computer readable storage medium of claim 8, wherein the at least one programmable circuitry is to determine the road wheel target angle further based on a grade of a driving surface associated with the vehicle.

11. The non-transitory computer readable storage medium of claim 8, wherein the at least one programmable circuitry is to determine the road wheel target angle further based on a traction of a driving surface associated with the vehicle.

12. The non-transitory computer readable storage medium of claim 8, wherein the at least one programmable circuitry is to determine the adjusted road wheel target angle if a difference between the road wheel target angle and an actual trajectory of the vehicle exceeds a second threshold.

13. The non-transitory computer readable storage medium of claim 12, wherein the at least one programmable circuitry is to adjust at least one of the first threshold or the second threshold based on a grade or traction of a driving surface associated with the vehicle.

14. The non-transitory computer readable storage medium of claim 8, wherein the at least one programmable circuitry is to determine the adjusted road wheel target angle if the difference between the road wheel target angle and the yaw data is exceeded and a vehicle speed is less than a third threshold.

15. A method comprising:
determining a road wheel target angle for road wheels of a vehicle based on environmental data associated with the vehicle and steering wheel angle data associated with the vehicle;
if a difference between the road wheel target angle and yaw data associated with the vehicle exceeds a first threshold, determining an adjusted road wheel target angle; and
causing a road wheel actuator of the vehicle to steer the road wheels based on the adjusted road wheel target angle.

16. The method of claim 15, wherein determining the road wheel target angle is further based on a grade of a driving surface associated with the vehicle.

17. The method of claim 15, wherein determining the road wheel target angle is further based on a traction of a driving surface associated with the vehicle.

18. The method of claim 15, wherein if a difference between the road wheel target angle and an actual trajectory of the vehicle exceeds a second threshold, further including determining the adjusted road wheel target angle.

19. The method of claim 18, further including adjusting at least one of the first threshold or the second threshold based on a grade or a traction of a driving surface associated with the vehicle.

20. The method of claim 15, wherein if the difference between the road wheel target angle and the yaw data is exceeded and a vehicle speed is less than a third threshold, determining the adjusted road wheel target angle.
